(19) United States
(12) Patent Application Publication
(10) Pub. No.: US 2008/0122337 A1
(43) Pub. Date: May 29, 2008

(54) Carbon-based material for electron emission source, electron emission source containing the carbon-based material, electron emission device including the electron emission source, and method of preparing electron emission source

(76) Inventor: Sung-Hee Cho, Suwon-si (KR)

Correspondence Address: ROBERT E. BUSHNELL, 1522 K STREET NW, SUITE 300, WASHINGTON, DC, 20005-1202, US

(21) Appl. No.: 11/976,752

(22) Filed: Oct. 26, 2007

(30) Foreign Application Priority Data
Nov. 27, 2006 (KR) 10-2006-0117945

(51) Int. Cl. H01J 1/14; C01B 31/00; C01B 31/02

(52) U.S. Cl. 313/346 R; 423/414

(57) ABSTRACT

A carbon-based material for electron emission sources, electron emission sources containing the carbon-based material, an electron emission device including the electron emission sources, and a method of preparing the electron emission sources are provided. The carbon-based material has a carbon-based material having at least one characteristic selected from the group consisting of a ratio of h2 to h1 (h2/h1)<1.3, and the ratio of FWHM2 to FWHM1 (FWHM2/FWHM1)>1.2, where the h2 denotes the relative intensity of a second peak which is a peak in a Raman shift range of 1350±20 cm⁻1, and the h1 denotes the relative intensity of a first peak which is a peak in a Raman shift range of 1580±20 cm⁻¹ in the Raman spectrum obtained by the radiation of a laser beam having a wavelength of 488±10 nm, 514.5±110 nm, 633±10 nm or 785±10 nm, the FWHM2 denotes the full width at half maximum of the second peak, and the FWHM1 denotes the full width at half maximum of the second peak. The electron emission sources containing the carbon-based material have long lifespan and a high current density.

### BACKGROUND OF THE INVENTION AND CLAIM OF PRIORITY

This application claims the priority of Korean Patent Application No. 10-2006-0117945, filed on Nov. 27, 2006, in the Korean Intellectual Property Office, the disclosure of which is incorporated herein in its entirety by reference.

1. Field of the Invention

The present invention relates to a carbon-based material for electron emission sources, an electron emission source, an electron emission device, and a method of preparing an electron emission source, and more particularly, to a carbon-based material for electron emission sources that has particular intensity ratios and full width at half maximum (FWHM) ratios of peaks in predetermined frequency ranges in the Raman spectrum, an electron emission source containing the carbon-based material, an electron emission device including the electron emission source, and a method of preparing the electron emission source.

2. Description of the Related Art

In electron emission devices, electrons are emitted from an electron emission source in cathodes by an electric field generated as a voltage is applied between an anode and cathodes. The electrons collide with a phosphor material on the cathodes, thereby emitting light.

Generally, electron emission devices use a hot cathode or a cold cathode as an electron emission source. Examples of electron emission devices using a cold cathode include field emission devices (FEDs), surface conduction emitters (SCEs), metal insulator metal (MIM) devices, metal insulator semiconductor (MIS) devices, and ballistic electron surface emitting (BSE) devices.

A FED utilizes the principle that when a material with a low work function or a high β function is used as an electron emission source, electrons are easily emitted in a vacuum due to an electric field difference. Devices including a tip structure primarily composed of Mo, Si, or the like, or carbon-based materials such as graphite and diamond like carbon (DLC) as electron emission sources have been developed. Recently, nanomaterials such as nanotubes and nanowires have been used as electron emission sources.

A SCE is formed by interposing a conductive thin film between a first electrode and a second electrode, which are arranged on a base substrate so as to face each other, and producing microcracks in the conductive thin film. When voltages are applied to the electrodes and an electric current flows along the surface of the conductive thin film, electrons are emitted from the microcracks, which are electron emission sources.

MIM and MIS type devices have a metal-insulator-metal structure and a metal-insulator-semiconductor structure, respectively, as electron emission sources. When voltages are applied to two metals or to the metal and the semiconductor, electrons are emitted while migrating and accelerating from the metal or the semiconductor having a high electromagnetic potential to the metal having a low electromagnetic potential.

A BSE device utilizes the principle that when the size of a semiconductor is reduced to less than the mean free path of electrons in the semiconductor, electrons travel without divergence. An electron-supplying layer composed of a metal or a semiconductor is formed on an ohmic electrode, and then an insulating layer and a metal thin film are formed thereon. When voltages are applied to the ohmic electrode and the metal thin film, electrons are emitted.

The electron emission source of the electron emission devices may include carbon nanotubes. Methods of preparing electron emission sources containing carbon nanotubes include, for example, a carbon nanotube growing method using chemical vapor deposition (CVD), etc., a paste method using a composition for forming electron emission sources that contain carbon nanotubes, etc. When using the paste method, the manufacturing costs decrease, and large-area electron emission sources can be obtained. Examples of the composition for forming electron emission sources that contains carbon nanotubes are disclosed, for example, in U.S. Pat. No. 6,436,221. Korean Patent Laid-open No. 2002-0076187 discloses an electron emission source containing carbon nanotubes.

However, the lifespan and the current density of conventional carbon-based electron emission sources are unsatisfactory, and thus improvements in this regard are still required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a carbon-based material for forming an improved electron emission source, an electron emission source containing the carbon-based material, an electron emission device including the electron emission source, and a method of preparing the electron emission source.

According to an aspect of the present invention, there is provided a carbon-based material for electron emission sources, the carbon-based material having at least one characteristic selected from the group consisting of a ratio of h2 to h1 (h2/h1)<1.3, and the ratio of FWHM2 to FWHM1 (FWHM2/FWHM1)>1.2, where the h2 denotes the relative intensity of a second peak which is a peak in the Raman shift range of 1350±20 cm⁻¹, the h1 denotes the relative intensity of a first peak which is a peak in a Raman shift range of 1580±20 cm⁻¹ in the Raman spectrum obtained by the radiation of a laser beam having a wavelength of 488±10 nm, 514.5±110 nm, 633±110 nm or 785±110 nm, the FWHM2 denotes the full width at half maximum of the second peak, and the FWHM1 denotes the full width at half maximum of the second peak.

According to another aspect of the present invention, there is provided an electron emission source containing the above-described carbon-based material.

According to another aspect of the present invention, there is provided an electron emission device including the above-described electron emission source.

According to another aspect of the present invention, there is provided a method of preparing an electron emission source, the method comprising: preparing a composition for forming the electron emission source that contains the above-described carbon-based material and a vehicle; applying the composition to a substrate; and heat-treating the composition applied to the substrate.

The electron emission sources according to the present invention containing the carbon-based material have long lifespan and a high current density.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a sectional view of an electron emission device according to an embodiment of the present invention;

FIG. 2 is a cross-sectional view of the electron emission device of FIG. 1;

FIGS. 3 and 4 illustrate the Raman spectra of carbon nanotubes used as a carbon-based material according to embodiments of the present invention;

FIG. 5 is a graph of current density versus time of electron emission sources prepared as examples according to the present invention; and

FIG. 6 is a graph of current density versus electric field of the electron emission sources prepared as examples according to the present invention.

### DETAILED DESCRIPTION OF THE INVENTION

Hereinafter, embodiments of the present invention will be described in detail.

A carbon-based material for electron emission sources according to an embodiment of the present invention exhibits a second peak in a Raman shift range of 1350±20 cm⁻¹ and a first peak in a Raman shift range of 1580±20 cm⁻¹ in a Raman spectrum obtained by the radiation of a laser beam having a wavelength of 488±10 nm, 514.5±10 nm, 633±10 nm or 785±10 nm.

Raman analysis is used to analyze the structure of carbon-based materials, such as carbon nanotubes, and is especially useful for evaluating surface morphology of carbon nanotubes. The Raman spectrum of a carbon-based material according to the embodiment of the present invention is obtained using a predetermined light source, for example, by radiating a laser beam having a wavelength of 488±10 nm, 514.5±10 nm, 633±10 nm or 785±10 nm. In the Raman spectrum of the carbon-based material according to the embodiment of the present invention measured by the radiation of a laser beam having a wavelength of 488±10 nm, 514.5±10 nm, 633±10 nm or 785±10 nm, a peak in a Raman shift range of 1350±20 cm⁻¹ and a peak in a Raman shift range of 1580±20 cm⁻¹ relate to whether structural defects of the carbon-based material exist or not. Hereinafter, the peak in the Raman shift range of 1350±20 cm⁻¹ in the Raman spectrum of the carbon-based material will be referred to as “second peak”, and the peak in the Raman shift range of 1580±20 cm⁻¹ will be referred to as “first peak”

In the Raman spectrum of the carbon-based material for electron emission sources according to the embodiment of the present invention measured by the radiation of a laser beam having a wavelength of 488±10 nm, 514.5±10 nm, 633±10 nm or 785±10 nm, when the relative intensity of the second peak is denoted by h2, and the relative intensity of the first peak is denoted by h1, the ratio of h2 to h1 (h2/h1)<1.3, preferably the ratio of h2 to h1<1.0, more preferably 0.03≦the ratio of h2 to h1≦0.56.

The relative intensity of a peak (second or first peak) means the difference between the Raman scattering intensity (at maximum point) of the peak and the background intensity (baseline). Background intensity means the intensity of light emitted by simple reflection, not the intensity of light (photoluminescence) emitted via excitation due to a particular molecular structure, when laser light is radiated. The tangent line of the lowest peak can be used as the background intensity. The relative intensity is in arbitrary units. Methods of measuring the Raman scattering intensity, the background intensity, and the relative intensities of peaks in Raman spectra are known to one of ordinary skill in the art.

In the Raman spectrum of the carbon-based material for electron emission sources according to the embodiment of the present invention obtained by the radiation of a laser beam having a wavelength of 488±10 nm, 514.5±10 nm, 633±10 nm or 785±10 nm, the ratio of full width at half maximum of the second peak (FWHM2) to full width at half maximum of the first peak (FWHM1) is more than 1.2 ((FWHM2/FWHM1)>1.2), preferably the ratio of FWHM2 to FWHM1>1.3, and more preferably 1.3≦ the ratio of FWHM2 to FWHM1≦2.0.

The full width at half maximum (FWHM2) of the second peak indicates the Raman shift frequency in a range corresponding to the median of the relative intensity (h2) of the second peak. The same meaning applies to the full width at halt maximum (FWHM1) of the first peak. Methods of measuring FWHM in Raman spectra are known to one of ordinary skill in the art.

The carbon-based material for electron emission sources according to an embodiment of the present invention include carbon-based materials which have the ratio of the relative intensity (h2) of the second peak to the relative intensity (h1) of the first peak, in their Raman spectrum obtained by the radiation of a laser beam having a wavelength of 488±10 nm, 514.5±10 nm, 633±10 nm or 785±10 nm, or/and the ratio of the full width at half maximum (FWHM2) of the second peak to the full width at half maximum (FWHM1) of the first peak in the above-described ranges. The carbon-based material according to an embodiment of the present invention may be carbon nanotubes.

The carbon-based material for electron emission sources according to an embodiment of the present invention may be various materials, for example, carbon nanotubes, fullerene, silicon carbide, etc. The carbon-based material for electron emission sources according to an embodiment of the present invention can be prepared using various methods. In particular, when the carbon-based material is carbon nanotubes, it can be prepared using various common methods, for example, but not limited to, a Hipco method, laser ablation, or chemical vapor deposition (CVD). When carbon nanotubes are formed using a CVD method, a catalyst for growing carbon nanotubes can be used. The catalyst for growing carbon nanotubes can be formed of, for example, at least one of Ni, Co and Fe. More particularly, the catalyst for growing carbon nanotubes can be a FeMoMgO catalyst, but is not limited thereto.

An electron emission source according to an embodiment of the present invention contains various carbon-based materials, wherein in the Raman spectra of the carbon-based materials measured by the radiation of a laser beam having a wavelength of 488±10 nm, 514.5±10 nm, 633±10 nm or 785±10 nm, the ratio of h2 and to h1≦1.3, preferably the ratio of h2 to h1<1.0, more preferably, 0.03≦ the ratio of h2 to h1≦0.56, or/and the ratio of FWHM2 to FWHM1>1.2, preferably the ratio of FWHM2 to FWHM1>1.3, more preferably 1.3≦ the ratio of FWHM2 to FWHM1≦2.0.

Since the electron emission source according to an embodiment of the present invention contains a carbon-based material with the above-defined relative intensity ratio and FWHM ratio of first and second peaks, the electron emission source has a long lifespan and a high current density. In general, the first peak in the Raman shift range of 1580±20 cm⁻¹ indicates the presence of a carbon-based material with no structural defect and superior crystallinity, and the second peak in the Raman shift range of 1350±20 cm⁻¹ indicates the presence of a carbon-based material with structural defects and inferior crystallinity. In the present invention, the ratio of h2 to h1<1.3 and the ratio of FWHM2 to FWHM1>1.2 means that a large quantity of the carbon-based materials have no structural defects and superior crystallinity.

For example, when the electron emission source according to an embodiment of the present invention contains carbon nanotubes as a carbon-based 11 material, and the Raman spectrum of the carbon nanotubes has peak values in the above-ranges, the binding of graphite sheets is strong, there is a large quantity of the carbon-based materials with no structural defect and superior crystallinity. Accordingly, the electron emission source has a long lifespan and a high current density.

The above-described electron emission source according to an embodiment of the present invention can be used in electron emission devices. An electron emission device according to an embodiment of the present invention includes: a substrate; cathodes formed on the substrate; gate electrodes which are arranged to be electrically insulated from the cathodes; an insulating layer which is interposed between the cathodes and the gate electrodes and insulates the cathodes from the gate electrodes; electron emission source holes that expose a portion of the cathodes; electron emission sources, which are contained in the electron emission source holes and electrically connected to the cathodes; and a phosphor layer facing the electron emission sources, wherein the electron emission sources include a carbon-based material. In the Raman spectrum of the carbon-based material obtained by the radiation of a laser beam having a wavelength of 488±10 nm, 514.5±10 nm, 633±10 nm or 785±10 nm, a ratio of h2 to h1 is less than 1.3 (i.e., h2/h1<1.3), preferably a ratio of h2 to h1<0.1, and more preferably, 0.03≦ the ratio of h2 to h1≦0.56, and/or a ratio of FWHM2 to FWHM1 is more than 1.2 (FWHM2/FWHM1>1.2), preferably a ratio of FWHM2 to FWHM1>1.3, and more preferably 1.3≦ the ratio of FWHM2 to FWHM1≦2.0.

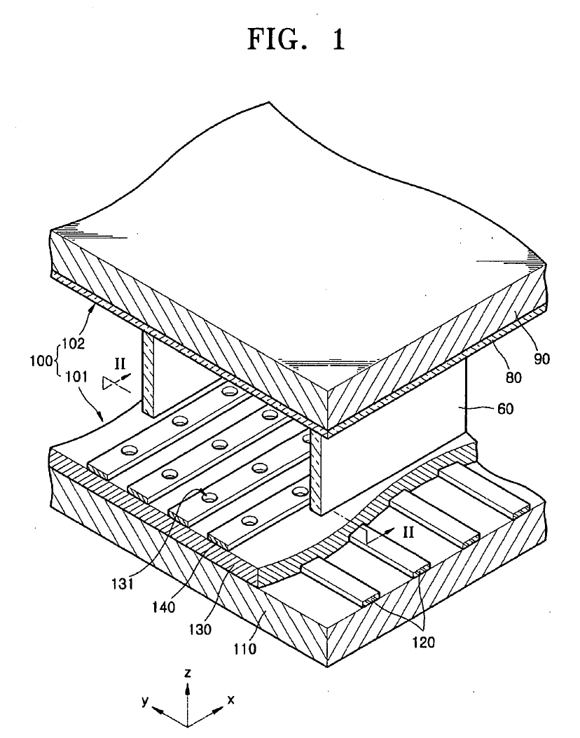

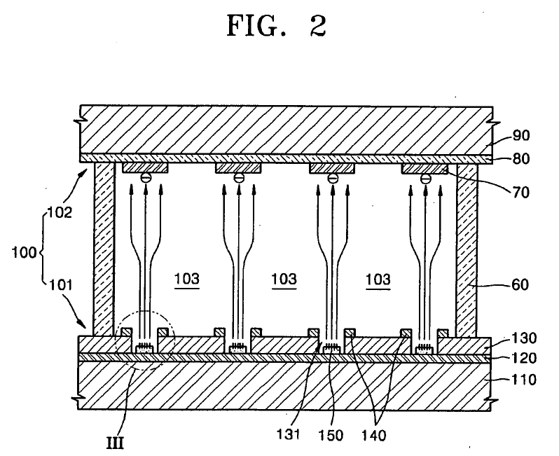

FIG. 1 illustrates an electron emission device 100 according to an embodiment of the present invention. FIG. 2 is a cross-sectional view of the electron emission device 100 of FIG. 1 taken along a line II-II of FIG. 1.

Referring to FIGS. 1 and 2, the electron emission device 100 includes a rear panel 101, a front panel 102, and a spacer 60 between the rear panel 101 and the front panel 102. The rear panel 101 includes a rear substrate 110, cathodes 120, gate electrodes 140, an insulating layer 130 and electron emission sources 150. The front panel 102 includes a front substrate 90, phosphor layers 70 and an anode 80.

The substrate 110 is formed of a plate-type material having a predetermined thickness. The cathodes 120 are arranged on the substrate 110 to extend in a first direction, and can be formed of a conventional electric conductive material. The gate electrodes 140 are disposed between the cathodes 120 and the insulating layer 130, and can be formed of a conventional electric conductive material as used in the cathodes 120.

The insulating layer 130 is disposed between the gate electrodes 140 and the cathodes 120 to insulate the cathodes 120 from the gate electrodes 140, thereby preventing shorts from occurring between the gate electrodes 140 and the cathodes 120. The insulating layer 130 includes electron emission source holes 131. The electron emission sources 150 are electrically connected to the cathodes 120.

The electron emission sources 150 are arranged to be electrically connected to the cathodes 120, and have a lower height than that of the gate electrodes 140. The electron emission sources can be formed of a carbon-based material having specific Raman spectra as described above. The carbon-based material is the same as described above, and thus a detailed description thereof is not repeated here.

The front panel 102 includes a front substrate 90, an anode 80 formed on the front substrate 90 and phosphor layers 70 formed on the anode 80. The anode electrode 80 applies high voltage required for accelerating electrons emitted from the electron emission sources 150 so that the electrons collide with the phosphor layers 70 at a high speed. Spacers 60 are positioned between the front panel 102 and the rear panel 101.

Although the present invention has been described with reference to the electron emission device with the triode structure shown in FIG. 1, the present invention includes electron emission devices with different structures, such as a diode structure, in addition to the triode structure described above. In addition, the present invention can be applied to an electron emission device with gate electrodes arranged below cathodes, an electron emission device with a grid/mesh that prevents preventing damage of gate electrodes and/cathodes caused by arc discharging and that focuses electrons emitted from the electron emission sources. In addition, an electron emission device according to another embodiment of the present invention can further include a focusing electrode formed on the upper portion of the gate electrodes. The focusing electrode focuses electrons emitted by electron emission sources towards phosphor layers, and prevents the electrons from being dispersed to the left and right. The electron emission device according to the current embodiment of the present invention can be used as a display device implementing a predetermined image or a light source.

A method of preparing electron emission sources according to an embodiment of the present invention includes preparing a composition for forming the electron emission sources that contains a carbon-based material with the ratio of h2 to h1 and/or the ratio of FWHM2 to FWHM1 in the above-described ranges and a vehicle, applying the composition for forming the electron emission sources to a substrate, and heat-treating the composition applied to the substrate.

In particular, a composition for forming electron emission sources that contains a carbon-based material and a vehicle is prepared.

The carbon-based material contained in the composition for forming electron emission sources has the ratio of h2 to h1 and/or the ratio of FWHM2 to FWHM1 in the above-described ranges. The vehicle contained in the composition for forming electron emission sources adjusts the printability and viscosity of the composition. The vehicle may contain a resin component and a solvent component. The resin component may include, but is not limited to, at least one of cellulose-based resins, such as ethyl cellulose, nitro cellulose, etc., acrylic resins, such as polyester acrylate, epoxy acrylate, urethane acrylate, etc., and vinyl resins, such as polyvinyl acetate, polyvinyl butylal, polyvinyl ether, etc. Some of the above-listed resin components also can act as photosensitive resins.

The solvent component may include at least one of, for example, terpineol, butyl carbitol (BC), butyl carbitol acetate (BCA), toluene, and texanol. It is preferable that the solvent component includes terpineol.

The amount of the resin component may be 100 to 500 parts by weight, preferably 200 to 300 parts by weight, based on 100 parts by weight of the carbon-based material. The amount of the solvent component may be 500 to 1,500 parts by weight, preferably 800 to 1,200 parts by weight, based on 100 parts by weight of the carbon-based material. When the amount of the vehicle composed of the resin component and the solvent component do not lie within the above-described ranges, the printability and the flowability of the composition deteriorate. In particular, when the amount of the vehicle is within these ranges, the composition for forming electron emission sources can have excellent printing properties and fluidity, and can prevent the drying time of the composition from being excessively long.

The composition for forming electron emission sources according to an embodiment of the present invention may further include an adhesive component, a photosensitive resin, and a photoinitiator or a filler, etc.

The adhesive component makes the electron emission sources adhere to the substrate. The adhesive component may be, for example, an inorganic binder, etc. Non-limiting examples of the inorganic binder include frit, silane, water glass, etc. A combination of at least two of these inorganic binders can be used. For example, the flit may be composed of PbO, ZnO, and B₂O₃. The frit may be preferred as the inorganic binder.

The amount of the inorganic binder in the composition for forming electron emission sources may be 10 to 50 parts by weight, preferably 15 to 35 parts by weight, based on 100 parts by weight of the carbon-based material. When the amount of the inorganic binder is less than 10 parts by weight based on 100 parts by weight of the carbon-based material, the adhesion is not sufficiently strong. When the amount of the inorganic binder is greater than 50 parts by weight based on 100 parts by weight of the carbon-based material, printability deteriorates.

The photosensitive resin is used to pattern the electron emission sources. Non-limiting examples of the photosensitive resin include acrylic monomers, benzophenone monomers, acetophenone monomers, thioxanthone monomers, etc. In particular, epoxy acrylate, polyester acrylate, 2,4-diethyloxanthone, 2,2-dimethoxy-2-phenylacetophenon, phenylacetophenone, etc., can be used as the photosensitive resin. The amount of the photosensitive resin may be 300 to 1,000 parts by weight, preferably 500 to 800 parts by weight, based on 100 parts by weight of the carbon-based material. When the amount of the photosensitive resin is less than 300 parts by weight based on 100 parts by weight of the carbon-based material, the exposure sensitivity decreases. When the amount of the photosensitive resin is greater than 1,000 parts by weight based on 100 parts by weight of the carbon-based material, developing is not effective.

The photoinitiator initiates cross-linking of the photosensitive resin when exposed to light. Non-limiting examples of the photosensitive resin include benzophenone, etc. The amount of the photoinitiator may be 300 to 1,000 parts by weight, preferably 500 to 800 parts weight, based on 100 parts by weight of the carbon-based material. When the amount of the photoinitiator is less than 300 parts by weight based on 100 parts by weight of the carbon-based material, the photosensitive resin may not be crosslinked effectively to form excellent patterns. When the amount of the photoinitiator is greater than 1,000 parts by weight based on 100 parts by weight of the carbon-based material, the manufacturing costs rise.

The filler improves the conductivity of the carbon-based material which is not strongly attached to the substrate. Non-limiting examples of the filler include Ag, Al, Pd, etc.

The viscosity of the composition for forming electron emission sources according to an embodiment of the present invention, which contains the above-described materials, may be 3,000 to 50,000 cps, preferably 5,000 to 30,000 cps. When the viscosity of the composition does not lie within the above range, it is difficult to handle the composition during processes.

Next, the composition for forming electron emission sources is applied to the substrate according to the pattern in which electron emission sources are to be formed. The substrate on which electron emission sources are to be formed may vary according to the type of an electron emission device to be formed, which is obvious to one of skill in the art. For example, when manufacturing an electron emission device with gate electrodes between the cathodes and the anode, the substrate can be the gate electrodes. When manufacturing an electron emission device with gate electrodes below the cathodes, the substrate can be an insulating layer insulating the cathodes from the gate electrodes.

The applying of the composition for forming electron emission sources can be performed, for example, using photolithography. More particularly, first, a separate photoresist layer is formed, and then the composition for forming electron emission sources is applied to the photoresist layer according to the pattern in which electron emission sources are to be formed and developed. Like this, the composition for electron emission sources can be applied according to the pattern in which electron emission sources are to be formed. However, the applying process is not limited thereto.

In addition, the composition for forming electron emission sources can be directly applied on the upper portion of a substrate with a thin line width, for example, a line width of 10 μm or less, using, for example, a spray method, a laser printing method or the like. However, the applying method is not limited thereto. Here, the composition for forming electron emission sources may not comprise photosensitive resin.

The composition for forming electron emission source applied to the substrate according to the pattern in which electron emission sources are formed as described above is heat-treated. Through the calcination, the adhesion of the carbon-based material in the composition to the substrate increases, a large portion of the vehicle volatilizes, the inorganic binder, etc., melts and solidifies, thereby improving the durability of the electron emission sources. The heat-treatment temperature is determined according to the volatilization temperature and time of the vehicle contained in the composition for forming electron emission sources. The heat-treatment temperature may be 400 to 500° C., preferably 450° C. When the heat-treatment temperature is lower than 400° C., the volatilization of the vehicle is insufficient. When the heat-treatment temperature is lower than 500° C., the manufacturing costs rise, and the substrate may be damaged.

The heat-treatment process may be performed in the presence of an inert gas. The inert gas may be for example, nitrogen gas, argon gas, neon gas, xenon gas, or a mixture of these gases. The use of the insert gas minimizes degradation of the carbon-based material.

The carbon-based material on the surface of the heat-treated structure is optionally subjected to an activation process. In an embodiment, the activation process may be implemented by coating a solution which is curable in film form through a thermal process, for example, an electron emission source surface treatment containing a polyimide polymer, on the surface of the heat-treated structure, thermally treating the coated structure to obtain a film; and separating the film. In another embodiment, the activation process may be implemented by pressing the surface of the heat-treated structure at a predetermined pressure using a roller with an adhesive portion that is driven by a driving source. Such an activation process, allows the carbon-based material to be exposed to the surface of the electron emission sources or to be vertically aligned.

A method of preparing electron emission sources according to another embodiment of the present invention include coating a catalyst for growing the carbon-based material on the substrate and thermally treating the substrate coated 11 with the catalyst for growing carbon-based material in the presence of hydrocarbon. The method of preparing electron emission sources according to the present invention is not limited to the above-described embodiments.

Hereinafter, the present invention will be described in greater detail with reference to the following examples. The following examples are for illustrative purposes and are not intended to limit the scope of the invention.

### EXAMPLES

### Synthesis Example 1

A substrate on which FeMoMg powder used as a catalyst for growing carbon nanotubes was applied was placed in a reactor for CVD, and CH₄, C₂H₂ and H₂ gases were injected to the reactor while the temperature of the reactor was maintained at 900° C. to synthesize carbon nanotubes. The obtained carbon nanotubes were multi-wall carbon nanotubes (MWCNT) having a diameter of 3-5 nm. These CNTs are referred to as CNT 1.

### Synthesis Example 2

Carbon nanotubes were synthesized in the same manner as in Synthesis Example 1, except that the temperature of the reactor was maintained at 1,000° C. These CNTs are referred to as CNT 2.

### Synthesis Example 3

Carbon nanotubes were synthesized in the same manner as in Synthesis Example 1, except that the temperature of the reactor was maintained at 1,100° C. These CNTs are referred to as CNT 3.

### Evaluation Example 1

### Analysis of the Raman Spectra of Carbon Nanotubes

### (CNTs)

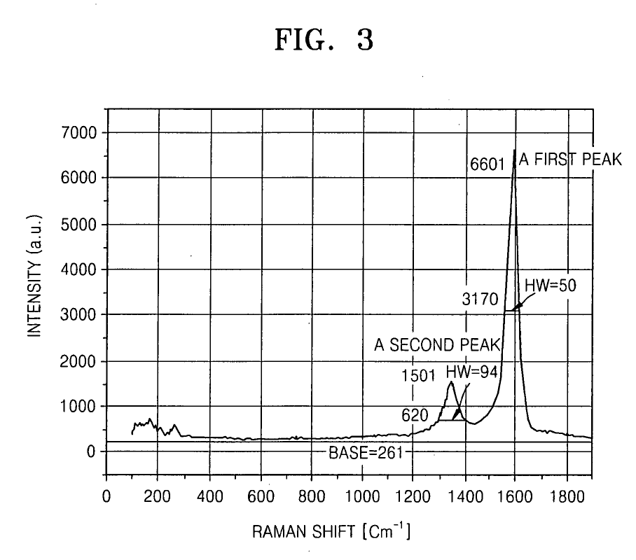

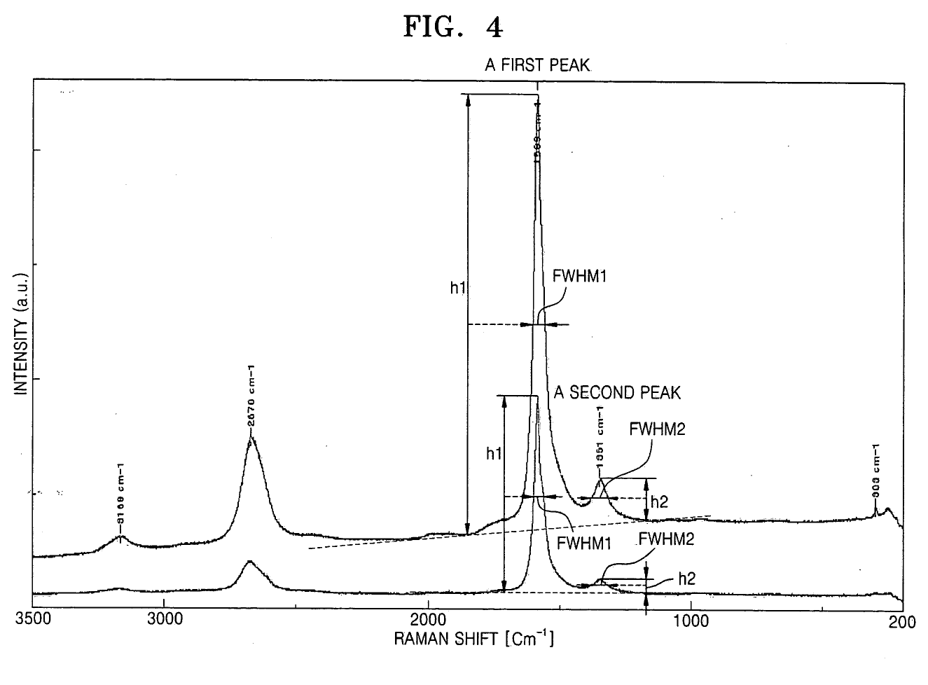

The Raman spectra of CNTs 1, 2, and 3 synthesized in Synthesis Examples 1, 2 and 3, respectively, were analyzed. The Raman spectra of CNT 1, 2, and 3 were measured by radiating a 514.5 nm laser beam and detecting the light emitted from the CNTs using a spectrometer (Jasco, Inc.). The results are shown in FIG. 3 (CNT 1) and FIG. 4 (CNT 2 and CNT 3). The y axis of each of the graphs of FIGS. 3 and 4 represents the relative intensity of light (thus, there is no unit).

In Table 2, in each of the Raman spectra of FIGS. 3 and 4, the relative intensity (h2) of a second peak in a Raman shift range of 1350±20 cm⁻¹, the relative intensity (h1) of a first peak in a Raman shift range of 1580±20 cm⁻¹, the ratio of h2 to h1, the full width at half maximum (FWHM2) of the second peak, the full width at half maximum (FWHM1) of the first peak, and the ratio of the FWHM2 to FWHM1 are summarized

TABLE 2

| | | | | | | FWHM2/ |
|---|---|---|---|---|---|---|
| CNT No. | h2 | h1 | h2/h1 | FWHM2 | FWHM1 | FWHM1 |
| CNT 1 | 1501 | 6601 | 0.227 | 94 | 50 | 1.88 |
| CNT 2 | 0.8 | 6.6 | 0.121 | 0.3 | 0.2 | 1.5 |
| CNT 3 | 0.2 | 2.9 | 0.069 | 0.2 | 0.15 | 1.33 |

* h2 and h1 indicate the relative intensities of light in arbitrary units.
* FWHM2 and FWHM1 are in cm⁻¹.

Referring to Table 2, the ratio of h2 to h1 of CNT 1 was 0.227, the ratio of h2 to h1 of CNT 2 was 0.121, and the ratio of h2 to h1 of CNT 3 was 0.069. The ratio of FWMH2 to FWMH1 of CNT 1 was 1.88, the ratio of FWMH2 to FWMH1 of CNT 2 was 1.5, and the ratio of FWMH2 to FWMH1 of CNT 3 was 1.33. These results indicate that the CNTs are suitable for use as electron emission sources according to the present invention.

### Example 1

1 g of CNT 1 in powder form, 0.2 g of frits (8000 L, Shinheung Ceramics Industry Co., Ltd.), 5 g of polyester acrylate, and 5 g of benzophenone were added into 10 g of terpineol and stirred to obtain a composition for forming electron emission sources having a viscosity of 30,000 cps. The composition for forming electron emission sources was applied to a substrate on which ITO electrodes had been formed according to the pattern in which electron emission sources were to be formed and exposed through a pattern mask to light using a parallel exposure system at an exposure energy of 2000 mJ/cm². After the exposure process, the resulting structure was developed using acetone and heat-treated at 450° C. in the presence of nitrogen gas to obtain electron emission sources. Next, the CNTs were vertically aligned through surface treatment. Next, a substrate with ITO anode thereon and a phosphor layer formed on the anode was arranged to face the substrate on which the electron emission sources had been formed, and spacers were formed between the two substrates to maintain a constant cell gap, thereby resulting an electron emission device, referred to as Sample 1.

### Example 2

An electron emission device was manufactured in the same manner as in Example 1, except that 1 g of CNT 2 in powder form was used instead of CNT 1 powder to prepare the composition for forming electron emission sources. The electron emission device was referred to as Sample 2.

### Example 3

An electron emission device was manufactured in the same manner as in Example 1, except that 1 g of CNT 3 in powder form was used instead of CNT 1 powder to prepare the composition for forming electron emission sources. The electron emission device was referred to as Sample 3.

### Evaluation Example 2

### Lifespan and Current Density Measurement

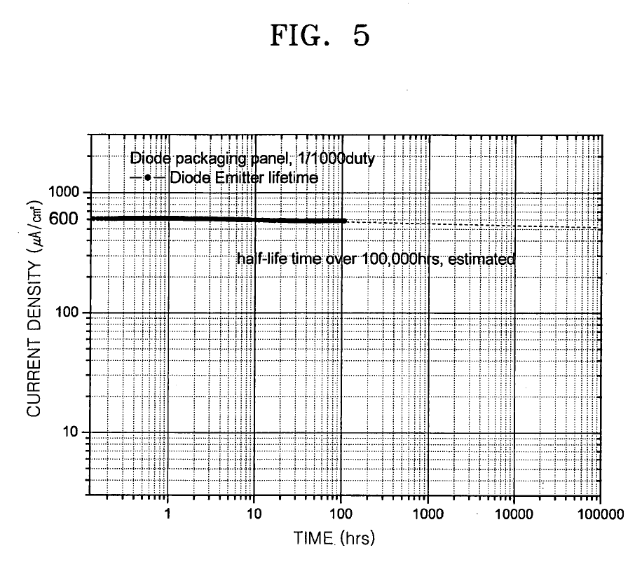

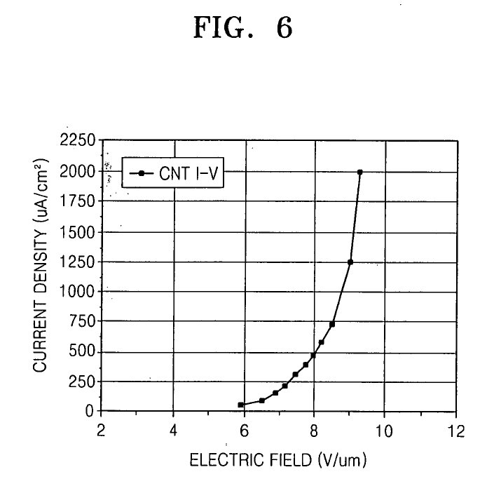

The lifespan and the current density of Sample 1 were measured using a pulse power source and an ammeter. FIG. 5 is a graph of current versus time of Sample 1. FIG. 6 is a graph of current density versus electric field of Sample 1. The lifespan measurement was performed by operating Sample 1 at a duty cycle of 1/1000 (10 μs, 100 Hz) to observe the change in current density. Referring to FIG. 5, when an initial current density was 600 μA/cm², the half-life time of the current density was 100,000 hours or more.

In addition, referring to FIG. 6, it can be seen that the electron emission sources according to the embodiment of the present invention have high voltage and current density.

Electron emission sources according to the present invention include a carbon-based material that has particular intensity ratios and/or FWHM ratios of peaks in predetermined frequency ranges in its Raman spectrum, and thus have long lifespan and a high current density. An electron emission device with improved reliability can be manufactured using the electron emission sources.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A carbon-based material for electron emission sources, the carbon-based material having at least one characteristic selected from the group consisting of a ratio of h2 to h1 (h2/h1)<1.3, and the ratio of FWHM2 to FWHM1 (FWHM2/FWHM1)>1.2, where the h2 denotes the relative intensity of a second peak which is a peak in the Raman shift range of 1350±20 cm⁻¹, the h1 denotes the relative intensity of a first peak which is a peak in a Raman shift range of 1580±20 cm⁻¹ in the Raman spectrum obtained by the radiation of a laser beam having a wavelength of 488±10 nm, 514.5±10 nm, 633±10 nm or 785±10 nm, the FWHM2 denotes the full width at half maximum of the second peak, and the FWHM1 denotes the full width at half maximum of the second peak.

2. The carbon-based material of claim 1, wherein the ratio of h2 to hi (h2/h1) is less than 1.3.

3. The carbon-based material of claim 1, wherein the ratio of FWHM2 to FWHM1 (FWHM2/FWHM1) is greater than 1.2.

4. The carbon-based material of claim 1, wherein the ratio of h2 to hi (h2/h1) is less than 1.3 and the ratio of FWHM2 to FWHM1 (FWHM2/FWHM1) is greater than 1.2.

5. The carbon-based material of claim 1, wherein 0.03≦ the ratio of h2 to h1≦0.56.

6. The carbon-based material of claim 1, wherein 1.3≦ the ratio of FWHM2 to FWHM1≦2.0.

7. An electron emission source, comprising:
a carbon-based material having at least one characteristic selected from the group consisting of a ratio of h2 to h1 (h2/h1)<1.3, and the ratio of FWHM2 to FWHM1 (FWHM2/FWHM1)>1.2, where the h2 denotes the relative intensity of a second peak which is a peak in a Raman shift range of 1350±20 cm⁻¹, and the h1 denotes the relative intensity of a first peak which is a peak in a Raman shift range of 1580±20 cm⁻¹ in the Raman spectrum obtained by the radiation of a laser beam having a wavelength of 488±10 nm, 514.5±10 nm, 633±10 nm or 785±10 nm, the FWHM2 denotes the full width at half maximum of the second peak, and the FWHM1 denotes the full width at half maximum of the second peak.

8. The electron emission source of claim 7, wherein the ratio of h2 to h1 (h2/h1) is less than 1.3.

9. The electron emission source of claim 7, wherein the ratio of FWHM2 to FWHM1 (FWHM2/FWHM1) is greater than 1.2.

10. The electron emission source of claim 7, wherein the ratio of h2 to h1 (h2/h1) is less than 1.3 and the ratio of FWHM2 to FWHM1 (FWHM2/FWHM1) is greater than 1.2.

11. The electron emission source of claim 8, wherein 0.03≦ the ratio of h2 to h1≦0.56.

12. The electron emission source of claim 8, wherein 1.3≦ the ratio of FWHM2 to FWHM1≦2.0.

13. An electron emission device comprising:
a substrate;
cathodes formed on the substrate, the cathodes having electron emission source holes;
gate electrodes electrically insulated from the cathodes;
an insulating layer interposed between the cathodes and the gate electrodes and insulating the cathodes from the gate electrodes;
electron emission sources positioned in the electron emission source holes and electrically connected to the cathodes, the electron emission sources comprising a carbon-based material having at least one characteristic selected from the group consisting of a ratio of h2 to h1 (h2/h1)<1.3, and the ratio of FWHM2 to FWHM1 (FWHM2/FWHM1)>1.2, where the h2 denotes the relative intensity of a second peak which is a peak in a Raman shift range of 1350±20 cm⁻¹, and the h1 denotes the relative intensity of a first peak which is a peak in a Raman shift range of 1580±20 cm⁻¹ in the Raman spectrum obtained by the radiation of a laser beam having a wavelength of 488±10 nm, 514.5±10 nm, 633±10 nm or 785±10 nm, the FWHM2 denotes the full width at half maximum of the second peak, and the FWHM1 denotes the full width at half maximum of the second peak; and
a phosphor layer facing the electron emission sources.

14. The electron emission device of claim 13, wherein the ratio of h2 to h1 (h2/h1) is less than 1.3.

15. The electron emission device of claim 13, wherein the ratio of FWHM2 to FWHM1 (FWHM2/FWHM1) is greater than 1.2.

16. The electron emission device of claim 13, wherein the ratio of h2 to h1 (h2/h1) is less than 1.3 and the ratio of FWHM2 to FWHM1 (FWHM2/FWHM1) is greater than 1.2.

17. The electron emission device of claim 13, wherein 0.03≦ the ratio of h2 to h1≦0.56.

18. The electron emission device of claim 13, wherein 1.3≦ the ratio of FWHM2 to FWHM1≦2.0.

19. The electron emission device of any one of claim 13, further comprising a focusing electrode formed on the upper portion of the gate electrodes to focus electrons emitted by the electron emission sources toward the phosphor layer.

20. The electron emission device of claim 13, being one of an electron emission display device and a light source.

21. A method of preparing electron emission sources comprising:
preparing a composition for forming electron emission sources comprising a carbon-based material and a vehicle, the carbon-based material having at least one characteristic selected from the group consisting of a ratio of h2 to h1 (h2/h1)<1.3, and the ratio of FWHM2 to FWHM1 (FWHM2/FWHM1)>1.2, where the h2 denotes the relative intensity of a second peak which is a peak in a Raman shift range of 1350±20 cm⁻1, and the h1 denotes the relative intensity of a first peak which is a peak in a Raman shift range of 1580±20 cm⁻¹ in the Raman spectrum obtained by the radiation of a laser beam having a wavelength of 488±10 nm, 514.5±10 nm, 633±10 nm or 785±10 nm, the FWHM2 denotes the full width at half maximum of the second peak, and the FWHM1 denotes the full width at half maximum of the second peak;
applying the composition to a substrate; and
heat-treating the composition applied to the substrate.

22. The method of claim 21, wherein the composition for forming the electron emission sources further contains a photoinitiator, and the applying the composition for forming the electron emission sources to the substrate comprises coating the composition on the substrate and exposing and developing the electron emission sources.
